(19) United States
(12) Patent Application Publication
(10) Pub. No.: US 2022/0398239 A1
(43) Pub. Date: Dec. 15, 2022

(54) INTELLIGENT SUPPORT BUNDLE COLLECTION

(71) Applicant: EMC IP Holding Company LLC, Hopkinton, MA (US)

(72) Inventors: Viral Kirtikumar Mehta, JamKhambhalia (IN); Omkar Anand Ekbote, Pune (IN); Nihar Jagdish Mukhiya, Mahad (IN)

(21) Appl. No.: 17/387,007

(22) Filed: Jul. 28, 2021

(30) Foreign Application Priority Data
Jun. 11, 2021 (IN) 202141026043

(51) Int. Cl. G06F 16/23; G06N 20/00

(52) U.S. Cl. CPC G06F 16/2358; G06N 20/00

(57) ABSTRACT

A method and system for intelligent support bundle collection. A support bundle may refer to a set of log files pertinent to components of a computing system, which may generally be created when issues or problems plaguing the computing system need to be triaged by technical support teams. Further, at least presently and for any complex computing system, a support bundle may include a plethora of log files that are not all necessary for assessing and/or resolving the aforementioned issues or problems. Accordingly, to reduce the set of log files, as well as minimize the storage space, processing time, and network bandwidth associated with handling the log files, the disclosed method and system propose intelligently selecting a subset of the log files relevant to a given user-defined issue or problem. Selection of the subset of log files may employ natural language processing (NLP) based machine learning, as well as runtime rules to collect dynamic, problem-specific log files.

### BACKGROUND

A support bundle may refer to a set of log files pertinent to components of a computing system, which may generally be created when issues or problems plaguing the computing system need to be triaged by technical support teams. Further, at least presently and for any complex computing system, a support bundle may include a plethora of log files that are not all necessary for assessing and/or resolving the aforementioned issues or problems.

### SUMMARY

In general, in one aspect, the invention relates to a method for intelligent support bundle collection. The method includes obtaining a problem description outlining a problem being experienced in a client data center, analyzing the problem description to extract a plurality of description keywords, processing the plurality of description keywords to predict a problem component of the client data center, identifying a specification file relevant to the problem component, collecting a subset of a log files set based on the specification file, and generating, to triage the problem, a support bundle comprising the subset of the log files set.

In general, in one aspect, the invention relates to a non-transitory computer readable medium (CRM). The non-transitory CRM includes computer readable program code, which when executed by a computer processor, enables the computer processor to perform a method for intelligent support bundle collection. The method includes obtaining a problem description outlining a problem being experienced in a client data center, analyzing the problem description to extract a plurality of description keywords, processing the plurality of description keywords to predict a problem component of the client data center, identifying a specification file relevant to the problem component, collecting a subset of a log files set based on the specification file, and generating, to triage the problem, a support bundle comprising the subset of the log files set.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart describing a method for intelligent support bundle collection in accordance with one or more embodiments of the invention.

FIG. 3 shows an exemplary computing system in accordance with one or more embodiments of the invention.

FIG. 4 shows an exemplary scenario in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

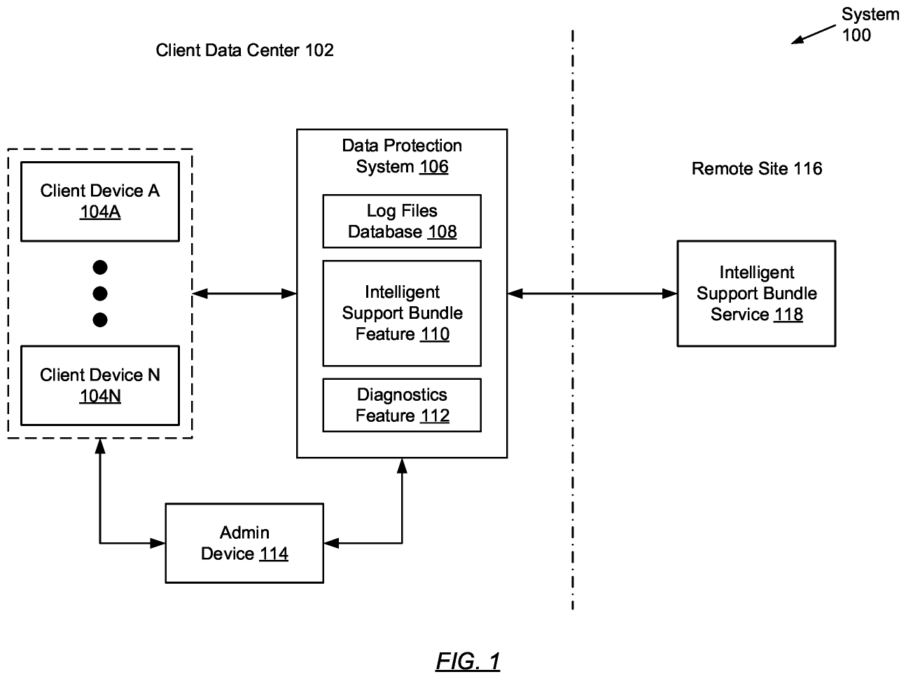

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for intelligent support bundle collection. A support bundle may refer to a set of log files pertinent to components of a computing system, which may generally be created when issues or problems plaguing the computing system need to be triaged by technical support teams. Further, at least presently and for any complex computing system, a support bundle may include a plethora of log files that are not all necessary for assessing and/or resolving the aforementioned issues or problems. Accordingly, to reduce the set of log files, as well as minimize the storage space, processing time, and network bandwidth associated with handling the log files, embodiments of the invention propose intelligently selecting a subset of the log files relevant to a given user-defined issue or problem. Selection of the subset of log files may employ natural language processing (NLP) based machine learning, as well as runtime rules to collect dynamic, problem-specific log files.

FIG. 1 shows a system in accordance with one or more embodiments of the invention. The system (100) may include a client data center (102) and a admin device (116). Each of these system (100) components is described below.

In one embodiment of the invention, the client data center (102) may represent any privately owned and maintained enterprise information technology (IT) environment. The client data center (102) may include any number and any configuration of IT sub-systems, including, but not limited to, one or more client devices (104A-104N), a data protection system (106), and an admin device (114). Each of these client data center (102) subcomponents is described below.

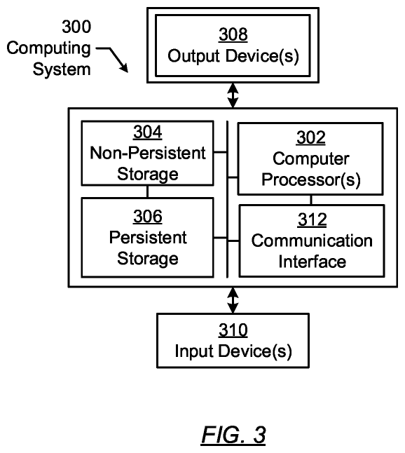

In one embodiment of the invention, a client device (104A-104N) may represent any physical appliance or computing system designed and configured to receive, generate, process, store, and/or transmit data, as well as to provide an environment in which one or more computer programs may execute thereon. The computer programs (not shown) may, for example, implement large-scale and complex data processing; or implement one or more services offered locally or over a network. Further, in providing an execution environment for any computer programs installed thereon, a client device (104A-104N) may include and allocate various resources (e.g., computer processors, memory, storage, virtualization, network bandwidth, etc.), as needed, to the computer programs and the tasks (or processes) instantiated thereby. One of ordinary skill will appreciate that a client device (104A-104N) may perform other functionalities without departing from the scope of the invention. Examples of a client device (104A-104N) may include, but are not limited to, a desktop computer, a laptop computer, a server, a mainframe, or any other computing system similar to the exemplary computing system shown in FIG. 3.

In one embodiment of the invention, the data protection system (106) may represent any data backup, archiving, and/or disaster recovery storage system. The data protection system (106) may be implemented using one or more servers (not shown). Each server may encompass a physical or virtual server, which may reside in an on-premises data center (e.g., the client data center (102)), a cloud computing environment, or a hybrid infrastructure thereof. Additionally, or alternatively, the data protection system (106) may be implemented using one or more computing systems similar to the exemplary computing system shown in FIG. 3. Furthermore, the data protection system (106) may include, but is not limited to, a log files database (108), an intelligent support bundle feature (110), and a diagnostics feature (112). Each of these data protection system (106) subcomponents is described below.

In one embodiment of the invention, the log files database (108) may refer to physical storage (or logical storage occupying at least a portion of the physical storage) on the data protection system (106), where any number of log files (not shown), pertinent to the client device(s) (104A-104N), may be consolidated. The log files database (108) may, at least in part, be implemented using persistent storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM). Further, a log file may refer to a data file that keeps a registry of events, processes, exceptions, messages, and/or communication between computer programs, which may transpire on any client device (104A-104N) or the data protection system (106) and may pertain to one or more hardware and/or software components thereof.

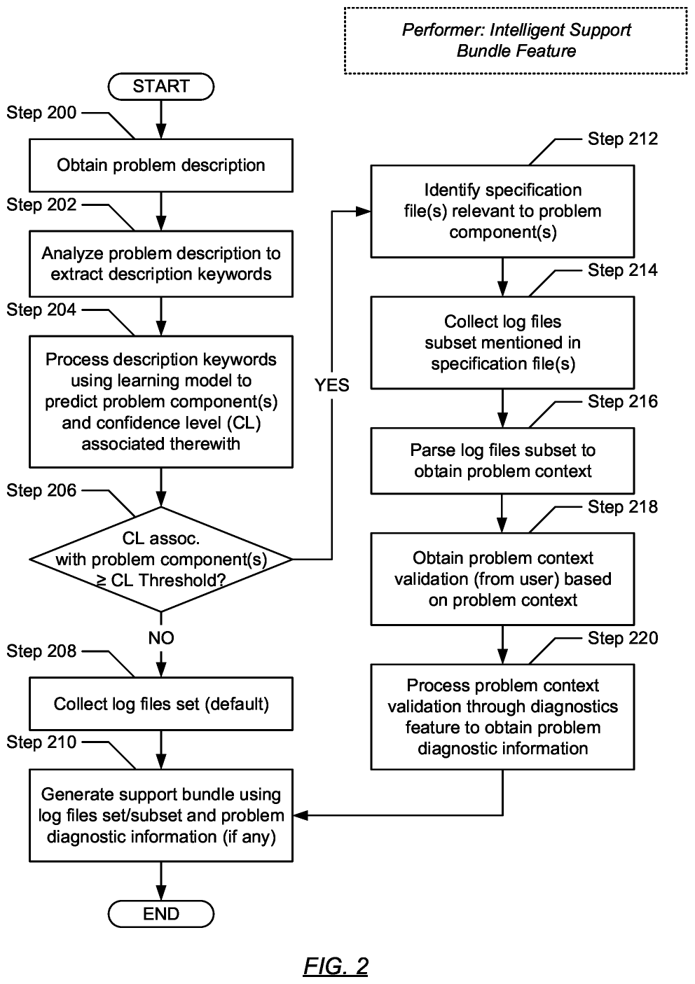

In one embodiment of the invention, the intelligent support bundle feature (110) may refer to a computer program that may execute on the underlying hardware of the data protection system (106), which may be responsible for intelligent support bundle collection. To that extent, the intelligent support bundle feature (110) may include functionality to perform the method outlined and described through FIG. 2, below. One of ordinary skill will appreciate that the intelligent support bundle feature (110) may perform other functionalities without departing from the scope of the invention.

In one embodiment of the invention, the diagnostics feature (112) may refer to a computer program that may execute on the underlying hardware of the data protection system (106), which may be responsible for performing diagnostic operations targeting any client device (104A-104N) or the data protection system (106). A diagnostic operation may entail the execution of computer instructions for determining an operational status of one or more hardware and/or software components of a computing system (e.g., a client device (104A-104N) or the data protection system (106)). To that extent, the diagnostics feature (112) may include functionality to generate diagnostic information detailing one or more issues or problems discovered during a diagnostic operation. The diagnostic information may include, but is not limited to, an assessment of the operational status of one or more hardware and/or software components of a computing system with which the discovered issues or problems may be associated; and guidance pertaining to the handling and/or resolution of the discovered issues or problems. One of ordinary skill will appreciate that the diagnostics feature (112) may perform other functionalities without departing from the scope of the invention.

In one embodiment of the invention, the admin device (114) may represent any physical appliance or computing system operated by one or more administrators of the client data center (102). An administrator may refer to an individual or entity whom may be responsible for overseeing client data center (102) operations and maintenance. To that extent, and at least as it pertains to embodiments of the invention, the admin device (114) may include functionality to enable an administrator to: submit problem descriptions for intelligent support bundle collection to the intelligent support bundle feature (110) on the data protection system (106); and validate problem contexts suggested by the intelligent support bundle feature (110) thereafter through processing of the submitted problem descriptions. These functionalities are described in further detail in FIG. 2, below. Further, one of ordinary skill will appreciate that the admin device (114) may perform other functionalities without departing from the scope of the invention.

In one embodiment of the invention, the remote site (116) may represent any IT environment where operations therein may be performed independent or asynchronous to any operations transpiring throughout the client data center (102). The remote site (116) may include any number and any configuration of IT sub-systems, including, but not limited to, an intelligent support bundle service (118), which is described below.

In one embodiment of the invention, the intelligent support bundle service (118) may represent IT infrastructure configured for servicing or maintaining the intelligent support bundle feature (110) on the data protection system (106). Specifically, the intelligent support bundle service (118) may be responsible for improving and/or optimizing a learning model through which the intelligent support bundle feature (110), at least in part, performs its above-mentioned functionalities. The intelligent support bundle service (118) may also apply extensive data pre-processing (e.g., data cleaning) methodologies to any data that may be used to train and/or validate the learning model. Through said data pre-processing, the intelligent support bundle service (118) may arrive at a rich vocabulary (i.e., a set of unique words used in a corpus of text surrounding the client device(s) (104A-104N) and/or the data protection system (106)). The rich vocabulary, in turn, may be used not only to tune the learning model, but also to parse problem descriptions to identify one or more problem keywords (described below) (see e.g., FIG. 2). One of ordinary skill, however, will appreciate that the intelligent support bundle service (118) may have other responsibilities without departing from the scope of the invention.

Furthermore, the intelligent support bundle service (118) may be implemented using one or more servers (not shown). Each server may represent a physical or virtual server, which may reside in an enterprise data center, a cloud computing environment, or any hybrid infrastructure thereof. Additionally, or alternatively, the intelligent support bundle service (118) may be implemented using one or more computing systems similar to the exemplary computing system shown in FIG. 3.

In one embodiment of the invention, the above-mentioned system (100) components (or subcomponents thereof) may communicate with one another through a network (not shown) (e.g., a local area network (LAN), a wide area network (WAN) such as the Internet, a mobile network, any other network type, or a combination thereof). The network may be implemented using any combination of wired and/or wireless connections. Further, the network may encompass various interconnected, network-enabled subcomponents (or systems) (e.g., switches, routers, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1 shows a configuration of components, other system (100) configurations may be used without departing from the scope of the invention.

FIG. 2 shows a flowchart describing a method for intelligent support bundle collection in accordance with one or more embodiments of the invention. The various steps outlined below may be performed by the intelligent support bundle feature (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

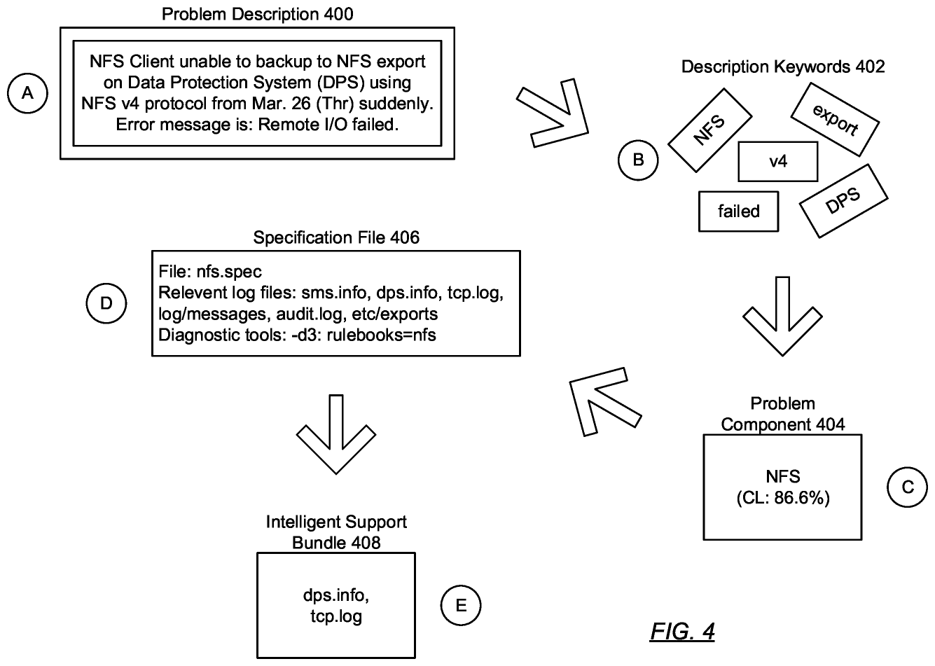

Turning to FIG. 2, in Step 200, a problem description is obtained. In one embodiment of the invention, the problem description may encompass user-specified text (e.g., one or more sentences) that describes a given problem being experienced by a user or administrator of a client data center (described above) (see e.g., FIG. 1). An example of a problem description is shown in FIG. 4, below.

In Step 202, the problem description (obtained in Step 200) is analyzed to extract one or more description keywords. In one embodiment of the invention, the description keyword(s) may each refer to an important term or expression that is representative of the underlying given problem. Extraction of the description keyword(s) may employ any existing keyword extraction algorithm—examples of which may include, but are not limited to, the weighting statistic based term frequency inverse document frequency (TF-IDF) algorithm, the unsupervised graph based TextRank algorithm, the transformer model based bidirectional encoder representations from transformers (BERT) algorithm, and the rapid automatic keyword extraction (RAKE) algorithm.

In Step 204, the description keyword(s) (extracted in Step 202) is/are processed to predict one or more problem components. In one embodiment of the invention, processing of the description keyword(s) may entail a natural language processing (NLP) based learning model. Generally, a learning model may refer to a machine learning and/or artificial intelligence algorithm configured for classification or prediction applications. A learning model may further encompass any learning algorithm capable of self-improvement through the processing of sample (e.g., training and/or validation) data. Examples of a learning model may include, but are not limited to, a neural network, a support vector machine, and a decision tree or random forest. Further, a problem component, predicted by the learning model, may refer to a physical (i.e., hardware) or logical (i.e., software) component of a client device or a data protection system (both described above) (see e.g., FIG. 1), which has been inferred as a probable source or cause of the given problem. In addition to providing one or more problem component predictions, the learning model may also provide a confidence level associated with each predicted problem component. For a given problem component, the confidence level may represent a numerical or percentage value indicative of the calculated probability that the given problem component is the underlying source or cause of the given problem.

In Step 206, a determination is made as to whether the confidence level(s) associated with the predicted problem component(s) (obtained in Step 204), separately or in combination, exceed a confidence level threshold. The confidence level threshold may refer to a predefined numerical or percentage value representative of a threshold probability. In one embodiment of the invention, if it is determined that the obtained confidence level(s) fall short of the confidence level threshold, then the method proceeds to Step 208. On the other hand, in another embodiment of the invention, if it is alternatively determined that the obtained confidence level(s) meet or exceed the confidence level threshold, then the method alternatively proceeds to Step 212.

In Step 208, following the determination (in Step 206) that the confidence level(s) associated with the predicted problem component(s) (obtained in Step 204) fall short of the above-mentioned confidence level threshold, a log files set is collected. In one embodiment of the invention, the log files set may encompass all the log files stored in a log files database residing on the data protection system (described above) (see e.g., FIG. 1).

In Step 210, following the collection of the log file set (described above) (in Step 208) or processing of a problem context validation (described below) (in Step 220), a support bundle is generated. Generally, a support bundle may refer to a collection of log files pertinent to components of a computing system, which may be created when issues or problems plaguing the computing system need to be triaged by technical support teams. Accordingly, in one embodiment of the invention, the support bundle may include the log files set (collected in Step 208). In another embodiment of the invention, the support bundle may include a subset of the log files set (i.e., a log files subset) (collected in Step 214) (described below). In yet another embodiment of the invention, the support bundle may include the aforementioned log files subset as well as problem diagnostic information (obtained in Step 220) (described below). Thereafter, the generated support bundle may be provided to an admin device (described above) (see e.g., FIG. 1) for scrutiny by a user or administrator.

In Step 212, following the alternative determination (in Step 206) that the confidence level(s) associated with the predicted problem component(s) (obtained in Step 204) meet or exceed the above-mentioned confidence level threshold, one or more specification files, relevant to the predicted problem component(s), is/are identified. In one embodiment of the invention, a specification file may refer to a predefined text file, associated with a given physical or logical component of a client device or the data protection system, which may specify one or more component-relevant log files, zero or more component-relevant log file filters, and/or zero or more component-relevant diagnostic tool recommendations. Each component-relevant log file may reference a log file pertinent to the given physical/logical component. Each component-relevant log file filter (if any) may reference a data attribute (e.g. problem timestamp window, client device Internet Protocol (IP) address, etc.), pertinent to the given physical/logical component, which can be used to refine relevant log file query results. Each component-relevant diagnostic tool recommendation (if any) may reference a diagnostic utility, offered via the diagnostics feature on the data protection system (described above) (see e.g., FIG. 1), which can be employed to discover diagnostic information pertinent to the given physical/logical component.

In one embodiment of the invention, a specification file may further include running command(s) and/or script(s). Such running command(s) and/or script(s) may refer to computer readable program code, which when executed, impose one or more runtime rules. The runtime rule(s), in turn, may each refer to a constraint or filter that may be applied onto the log files, thereby further refining any log file query results.

In Step 214, based on the specification file(s) (identified in Step 212), a subset of all the log files, maintained in a log files database on the data protection system (described above) (see e.g., FIG. 1), is collected. Specifically, in one embodiment of the invention, the collected subset of the log files set (i.e., log files subset) may include the component-relevant log file(s) listed in the specification file(s).

In Step 216, the log files subset (collected in Step 214) is parsed to obtain a problem context. In one embodiment of the invention, the problem context may refer to contextual information descriptive of the circumstance(s) surrounding the given problem. By way of examples, the problem context may identify a problematic client device, a failed backup job, a timestamp encoding the occurrence of the given problem, a network bandwidth and/or network latency issue, a failure of a name service server, a failure of a hostname resolution server, a disk failure, and a cloud connectivity issue.

In Step 218, a validation of the problem context (obtained in Step 216) is obtained. Specifically, in one embodiment of the invention, the problem context may be presented to a user or administrator, via an admin device, for verification. In being prompted, the user/administrator may omit any presented contextual information that is irrelevant to the given problem and, accordingly, provide back just the relevant contextual information (if any).

In Step 220, the problem relevant contextual information (if any) (validated in Step 218) is processed. That is, in one embodiment of the invention, the log files subset (collected in Step 214) may be further refined through application of the problem relevant contextual information, as well as the log file filter(s) (if any) specified in the specification file(s) (identified in Step 212). Additionally, or alternatively, based on the problem relevant contextual information, problem diagnostic information may be discovered through use of any component-relevant diagnostic tool recommendation(s) also specified in the specification file(s).

Hereinafter, the method proceeds to Step 210 (described above).

FIG. 3 shows an exemplary computing system in accordance with one or more embodiments of the invention. The computing system (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a central processing unit (CPU) and/or a graphics processing unit (GPU). The computing system (300) may also include one or more input devices (310), such as a touchscreen, keyboard, mouse, microphone, touchpad, electronic pen, or any other type of input device. Further, the communication interface (312) may include an integrated circuit for connecting the computing system (300) to a network (not shown) (e.g., a local area network (LAN), a wide area network (WAN) such as the Internet, mobile network, or any other type of network) and/or to another device, such as another computing device.

In one embodiment of the invention, the computing system (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

FIG. 4 shows an exemplary scenario in accordance with one or more embodiments of the invention. The exemplary scenario, illustrated through FIG. 4 and described below, is for explanatory purposes only and not intended to limit the scope of the invention.

Turning to FIG. 4, consider a scenario where a user of a client device (see e.g., FIG. 1) runs into a problem while attempting to mount a backup directory exported by the data protection system using a network file system (NFS) protocol. Triaging of the problem, in accordance with one or more embodiments of the invention, may be implemented as follows:
A. User provides an intelligent support bundle feature (described above) (see e.g., FIG. 1) with a problem description (400) outlining the problem—i.e., “NFS Client unable to backup to NFS export on Data Protection System (DPS) using NFS v4 protocol from March 26 (Thr) suddenly. Error message is: Remote I/O failed.”
B. The intelligent support bundle feature, accordingly, analyzes the provided problem description (400) to extract a number of description keywords (402)— i.e., “NFS”, “export”, “v4”, “failed”, “DPS”
C. The intelligent support bundle feature further processes the extracted description keywords (402), via a NLP-based learning model, to predict a problem component (404)— i.e., NFS—and to calculate a confidence level associated with the prediction (e.g., 86.6%)
D. Based on the confidence level of the prediction exceeding a predefined confidence level threshold (e.g., 80%), the intelligent support bundle feature proceeds in identifying a specification file (406), which pertains to the predicted problem component (404); relevant log files—i.e., “sms.info”, “dps.info”, “tcp.log”, “log/messages”, “audit.log”, “etc/exports”—specified in the specification file (406) are subsequently parsed to derive a problem context (not shown) surrounding the problem
E. The intelligent support bundle feature prompts the user to validate the derived problem context; the validated problem context, alongside problem diagnostic information discovered using the diagnostic tool recommendation cited in the specification file (406), refine the relevant log files to a subset thereof—i.e., “dps.info”, “tcp.log”—which are included in support bundle (408) and presented to the user

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for intelligent support bundle collection, comprising:
obtaining a problem description outlining a problem being experienced in a client data center;
analyzing the problem description to extract a plurality of description keywords;
processing the plurality of description keywords to predict a problem component of the client data center;
identifying a specification file relevant to the problem component;
collecting a subset of a log files set based on the specification file; and
generating, to triage the problem, a support bundle comprising the subset of the log files set.

2. The method of claim 1, wherein the plurality of description keywords is processed using a learning model.

3. The method of claim 2, wherein the learning model is natural language processing (NLP) based.

4. The method of claim 1, wherein processing the plurality of description keywords further obtains a confidence level associated with the problem component.

5. The method of claim 4, further comprising:
prior to collecting the subset of the log files set:
making a determination that the confidence level exceeds a confidence level threshold,
wherein the subset of the log files set is collected as a result of the determination.

6. The method of claim 1, further comprising:
prior to generating the support bundle:
parsing the subset of the log files set to obtain a problem context surrounding the problem; and
refining the subset of the log files set based on the problem context.

7. The method of claim 1, further comprising:
prior to generating the support bundle:
discovering, using a diagnostic tool recommendation specified in the specification file, problem diagnostic information relevant to the problem and the problem component,
wherein the support bundle further comprises the problem diagnostic information.

8. The method of claim 1, further comprising:
obtaining a second problem description outlining a second problem being experienced in the client data center;
analyzing the second problem description to extract a second plurality of description keywords;
processing the second plurality of description keywords to predict a second problem component of the client data center;
collecting the log files set; and
generating, to triage the second problem, a second support bundle comprising the log files set.

9. The method of claim 8, wherein processing the second plurality of description keywords further obtains a confidence level associated with the second problem component.

10. The method of claim 9, further comprising:
prior to collecting the log files set:
making a determination that the confidence level falls short of a confidence level threshold,
wherein the log files set is collected as a result of the determination.

11. A non-transitory computer readable medium (CRM) comprising computer readable program code, which when executed by a computer processor, enables the computer processor to perform a method for intelligent support bundle collection, the method comprising:
obtaining a problem description outlining a problem being experienced in a client data center;
analyzing the problem description to extract a plurality of description keywords;
processing the plurality of description keywords to predict a problem component of the client data center;
identifying a specification file relevant to the problem component;
collecting a subset of a log files set based on the specification file; and
generating, to triage the problem, a support bundle comprising the subset of the log files set.

12. The non-transitory CRM of claim 11, wherein the plurality of description keywords is processed using a learning model.

13. The non-transitory CRM of claim 12, wherein the learning model is natural language processing (NLP) based.

14. The non-transitory CRM of claim 11, wherein processing the plurality of description keywords further obtains a confidence level associated with the problem component.

15. The non-transitory CRM of claim 14, the method further comprising:
prior to collecting the subset of the log files set:
making a determination that the confidence level exceeds a confidence level threshold,
wherein the subset of the log files set is collected as a result of the determination.

16. The non-transitory CRM of claim 11, the method further comprising:
prior to generating the support bundle:
parsing the subset of the log files set to obtain a problem context surrounding the problem; and
refining the subset of the log files set based on the problem context.

17. The non-transitory CRM of claim 11, the method further comprising:
prior to generating the support bundle:
discovering, using a diagnostic tool recommendation specified in the specification file, problem diagnostic information relevant to the problem and the problem component,
wherein the support bundle further comprises the problem diagnostic information.

18. The non-transitory CRM of claim 11, the method further comprising:
obtaining a second problem description outlining a second problem being experienced in the client data center;
analyzing the second problem description to extract a second plurality of description keywords;
processing the second plurality of description keywords to predict a second problem component of the client data center;
collecting the log files set; and
generating, to triage the second problem, a second support bundle comprising the log files set.

19. The non-transitory CRM of claim 18, wherein processing the second plurality of description keywords further obtains a confidence level associated with the second problem component.

20. The non-transitory CRM of claim 19, the method further comprising:
prior to collecting the log files set:
making a determination that the confidence level falls short of a confidence level threshold,
wherein the log files set is collected as a result of the determination.
